(19) United States
(12) Patent Application Publication
(10) Pub. No.: US 2013/0009768 A1
(43) Pub. Date: Jan. 10, 2013

(54) SOUND PRODUCING DEVICE FOR A VEHICLE, AND RECORDING MEDIUM AND INFORMATION PROCESSING METHOD FOR A SOUND PRODUCING DEVICE FOR A VEHICLE

(75) Inventor: Ken TERAO, Iruma-shi (JP)

(73) Assignee: CASIO COMPUTER CO., LTD., Tokyo (JP)

(21) Appl. No.: 13/541,104

(22) Filed: Jul. 3, 2012

(30) Foreign Application Priority Data
Jul. 6, 2011 (JP) 2011-149947

(51) Int. Cl. B60Q 1/26

(52) U.S. Cl. 340/463

(57) ABSTRACT

A DSP subtracts the sound pressure Pgen of a notification sound from the sound pressure Pout of an octave band including the notification sound among the sound pressures P1 to P8 of octave bands having center frequencies f1 to f8 acquired by the octave analysis of ambient noises including the notification sound, and thereby acquires the octave band characteristics of only the ambient noises. Next, the DSP detects the sound pressure Pmin of an octave band of the ambient noises which has the lowest sound pressure and the sound pressure Pmax of an octave band of the ambient noises which has the highest sound pressure from these octave band characteristics. Then, the DSP generates an output waveform of the sound pressure Pgen that is almost equal to the sound pressure Pmax of the octave band having the highest sound pressure in the octave band having the lowest sound pressure.

### CROSS-REFERENCE TO RELATED APPLICATION

This application is based upon and claims the benefit of priority from the prior Japanese Patent Application No. 2011-149947, filed Jul. 6, 2011, the entire contents of which is incorporated herein by reference.

### BACKGROUND OF THE INVENTION

1. Field of the Invention

The present invention relates to a sound producing device for a vehicle that generates a notification sound to notify pedestrians that a vehicle is approaching, and a recording medium and an information processing method for a sound producing device for a vehicle.

2. Description of the Related Art

The noise of electric vehicles (EV) and hybrid vehicles (HV) which use a motor rather than an engine when running at low speed is too quiet and pedestrians are often not aware that a vehicle is approaching. Therefore, safety measures regarding this problem have been demanded for years, and accordingly various devices for notifying pedestrians of the presence of an approaching vehicle have been developed in recent years. For example, Japanese Patent Application Laid-Open (Kokai) Publication No. 07-209424 discloses a technology by which, when the presence of a pedestrian walking ahead is detected in the traveling direction of a vehicle, an alert indicating that a vehicle is approaching from behind is issued to the pedestrian.

However, in quiet locations such as residential areas, merely emitting an alert sound towards a pedestrian as disclosed in Japanese Patent Application Laid-Open (Kokai) Publication No. 07-209424 may cause a noise disturbance. In addition, in noisy locations such as busy streets, it is difficult for pedestrians to recognize an alert sound because the alert sound is lost among the ambient noise (noise from the surrounding area). That is, there is a problem in that a notification sound that is not lost among ambient noise even in noisy locations and does not unnecessarily cause a noise disturbance in quiet locations cannot be generated.

### SUMMARY OF THE INVENTION

The present invention has been conceived in light of the above-described problem. An object of the present invention is to provide a sound producing device for a vehicle, and a recording medium and an information processing method for the sound producing device capable of generating a notification sound that is not lost among ambient noise even in noisy locations and does not unnecessarily cause a loud noise disturbance in quiet locations.

In order to achieve the above-described object, in accordance with one aspect of the present invention, there is provided a sound producing device for a vehicle comprising: an analyzing section which picks up noises around the vehicle and analyzes frequency characteristics of the picked up noises; an acquiring section which acquires frequency characteristics of ambient noises from the noises around the vehicle which have been analyzed by the analyzing section; a detecting section which detects (a) a sound pressure of a frequency having a lowest sound pressure and (b) a sound pressure of a frequency having a highest sound pressure from the frequency characteristics of the ambient noises acquired by the acquiring section; and a sound producing section which produces a notification sound at the frequency of the ambient noises having the lowest sound pressure which has been detected by the detecting section, and at a sound pressure corresponding to the highest sound pressure of the ambient noises detected by the detecting section.

In accordance with another aspect of the present invention, there is provided a non-transitory computer-readable storage medium having stored thereon a program that is executable by a computer used in a sound producing device for a vehicle, the program being executable by the computer to perform functions comprising: analysis processing for picking up noises around the vehicle and analyzing frequency characteristics of the picked up noises; acquisition processing for acquiring frequency characteristics of ambient noises from the noises around the vehicle which have been analyzed by the analysis processing; detection processing for detecting (a) a sound pressure of a frequency having a lowest sound pressure and (b) a sound pressure of a frequency having a highest sound pressure from the frequency characteristics of the ambient noises acquired by the acquiring section; and sound production processing for produces a notification sound at the frequency of the ambient noises having the lowest sound pressure which has been detected by the detection processing, and at a sound pressure corresponding to the highest sound pressure of the ambient noises detected by the detection processing.

In accordance with another aspect of the present invention, there is provided an information processing method used for a sound producing device for a vehicle, comprising: an analyzing step of picking up noises around the vehicle and analyzing frequency characteristics of the picked up noises; an acquiring step of acquiring frequency characteristics of ambient noises from the noises around the vehicle which have been analyzed in the analyzing step; a detecting step of detecting (a) a sound pressure of a frequency having a lowest sound pressure and (b) a sound pressure of a frequency having a highest sound pressure from the frequency characteristics of the ambient noises acquired in the acquiring step; and a sound production step of producing a notification sound at the frequency of the ambient noises having the lowest sound pressure which has been detected in the detecting step, and at a sound pressure corresponding to the highest sound pressure of the ambient noises detected in the detecting step.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram showing the overall structure of a sound producing device 100 according to an embodiment;

FIG. 2 is a flowchart of operations in the main routine;

FIG. 3 is a flowchart of operations in input waveform analysis processing;

FIG. 4 is a diagram showing an example of octave band center frequencies; and

FIG. 5 is a flowchart of operations in output waveform generation processing.

### DETAILED DESCRIPTION OF THE PREFERRED EMBODIMENT

An embodiment of the present invention will hereinafter be described with reference to the drawings.

A. Structure

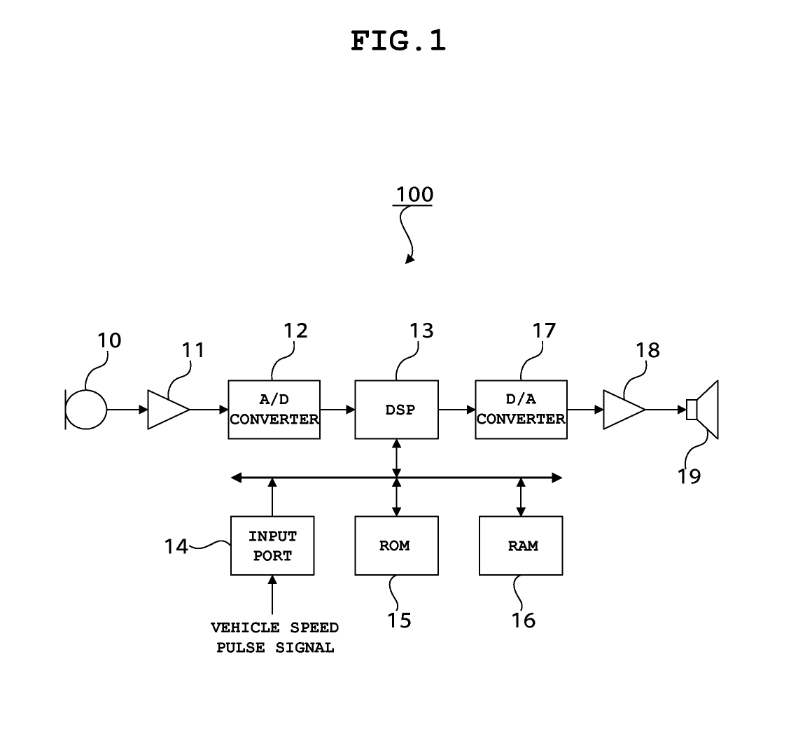

FIG. 1 is a block diagram showing the structure of a sound producing device 100 according to the embodiment of the present invention. The sound producing device 100 is mounted in a vehicle and constituted by a microphone 10, an amplifier 11, an analog-to-digital (A/D) converter 12, a digital signal processor (DSP) 13, an input port 14, a read-only memory (ROM) 15, a random access memory (RAM) 16, a digital-to-analog (D/A) converter 17, an amplifier 18 and a speaker 19.

The microphone 10 is non-directional and set in, for example, a roof portion of a vehicle. This microphone 10 picks up noises around a vehicle (hereinafter, referred to as ambient noises) and outputs ambient noise signals. The amplifier 11 amplifies ambient noise signals outputted from the microphone 10 to a predetermined level and supplies the amplified ambient noise signals to the A/D converter 12 for the next processing. The A/D converter 12 performs pulse-code modulation (PCM) sampling of ambient noise signals at a predetermined sampling frequency and generates ambient noise data.

The DSP 13 runs various programs stored in the ROM 15 and controls each section of the device. Characteristic processing operations of the DSP 13 related to the gist of the present invention will be described later. The input port 14 loads therein vehicle speed pulse signals generated on the vehicle side and supplies it to the DSP 13. The ROM 15 includes a program area and a data area, and the program area stores data of various programs to be run by the DSP 13. The various programs herein include the main routine, input waveform analysis processing, and output waveform generation processing, described hereafter.

The RAM 16 includes a work area, an input buffer area, and an output buffer area. The work area of the RAM 16 temporarily stores various register and flag data that are used for calculation by the DSP 13. The input buffer area of the RAM 16 loads therein ambient noise data amounting to a predetermined amount of time (amounting to a predetermined number of samples) which have been outputted from the A/D converter 12, under the control of the DSP 13. Note that ambient noise data amounting to a predetermined amount of time which have been stored in the input buffer area are used in the input waveform analysis processing described hereafter. The output buffer area of the RAM 16 temporarily stores notification sound data amounting to a predetermined amount of time (amounting to a predetermined number of samples) which have been generated by the output waveform generation processing described hereafter.

The D/A converter 17 converts notification sound data read out from the output buffer area of the RAM 16 into analog notification sound signals and outputs the analog notification sound signals under the control of the DSP 13. The amplifier 18 amplifies notification sound signals outputted from the D/A converter 17 to a predetermined level, and supplies the sound signals to the speaker 19. The speaker 19 is arranged, for example, near the front bumper of a vehicle and emits a notification sound in the traveling direction of the vehicle.

B. Operations

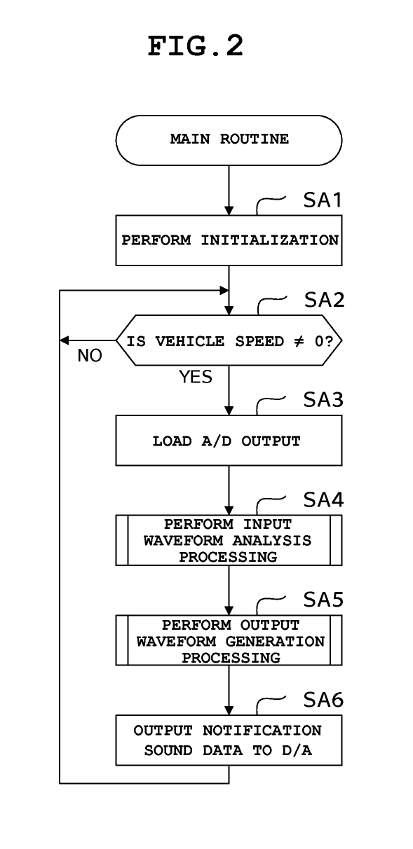

Next, operations of the DSP 13 included in the sound producing device 100 will be described with reference to FIG. 2 to FIG. 5. Hereafter, operations in the main routine will first be described, and then operations in the input waveform analysis processing and the output waveform generation processing called from the main routine will be described.

(1) Operations in the Main Routine

When the sound producing device 100 structured as described above is turned ON, the DSP 13 runs the main routine shown in FIG. 2 and proceeds to Step SA1. At Step SA1, the DSP 13 performs initialization for initializing the input and output buffer areas of the RAM 16, in addition to resetting various register and flag data stored in the work area of the RAM 16 to zero or default settings. When the initialization is completed, the DSP 13 proceeds to Step SA2 and starts vehicle speed monitoring to judge whether or not the vehicle speed is “0”, or in other words, whether or not the vehicle is moving, based on vehicle speed pulse signals inputted from the vehicle side via the input port 14.

When the vehicle is not moving, the judgment result at Step SA2 is “NO”, and therefore the DSP 13 continues monitoring of the vehicle speed. When vehicle speed pulse signals proportional to the rotation of the wheels are inputted and the travel motion of the vehicle is detected as a result, the judgment result at Step SA2 is “YES”, and therefore the DSP 13 proceeds to Step SA3. At Step SA3, the DSP 13 loads, into the input buffer area of the RAM 16, ambient noise data amounting to a predetermined amount of time (amounting to a predetermined number of samples) which have been outputted from the A/D converter 12.

Next, at Step SA4, the DSP 13 performs the input waveform analysis processing. As described later, in the input waveform analysis processing, the DSP 13 sequentially reads out the ambient noise data amounting to a predetermined amount of time (amounting to a predetermined number of samples) which have been loaded into the input buffer area of the RAM 16, and performs fast Fourier transform (FFT) processing on the ambient noise data. Subsequently, on frequency analysis results (amplitude spectrum for each frequency component) acquired thereby, the DSP 13 performs octave analysis for detecting the sound pressures (octave band levels) of respective octave bands having center frequencies f1 to f8. If a notification sound is being outputted and emitted from the speaker 19, the DSP 13 acquires the sound pressure Pout of an octave band including the notification sound from octave band characteristics (the sound pressures P1 to P8 of octave bands having the center frequencies f1 to f8) acquired by the octave analysis of ambient noises including the notification sound.

Then, if the sound pressure Pout is within an appropriate range (when the status flag “status” is “OK”), the DSP 13 subtracts the sound pressure Pgen of the notification sound which is actually being emitted, from the sound pressure Pout of the octave band including the notification sound. Subsequently, the DSP 13 corrects the sound pressure of an octave band having a center frequency Fn to the sound pressure Pn of only the ambient noises, and thereby acquires the octave band characteristics (the sound pressures P1 to P8 of octave bands having the center frequencies f1 to f8) of only the ambient noises. Then, the DSP 13 detects the center frequency fmin and the sound pressure Pmin of an octave band of the ambient noises which has the lowest sound pressure, and the center frequency fmax and the sound pressure Pmax of an octave band of the ambient noises which has the highest sound pressure, from the octave characteristics (the sound pressures P1 to P8 of the octave bands having the center frequencies f1 to f8) of only the ambient noises.

Next, at Step SA5, the DSP 13 performs the output waveform generation processing. As described later, in the output waveform generation processing, the DSP 13 generates an output waveform (notification sound data) of the sound pressure Pgen controlled to come within an appropriate range (Pmax<Pout<Pmax+Pc) where the sound pressure Pout of the notification sound in the octave band (center frequency fmin) of the ambient noises which has the lowest sound pressure is almost equal to the sound pressure Pmax of the octave band (center frequency fmax) of the ambient noises which has the highest sound pressure, based on the octave analysis results acquired by the input waveform analysis processing. Then, the DSP 13 stores the generated output waveform in the output buffer area of the RAM 16.

Next, at Step SA6, the DSP 13 reads out the notification sound data (output waveform) stored in the output buffer area of the RAM 16 and supplies it to the D/A converter 17. As a result, the notification sound data is converted to analog notification sound signals, the notification sound signals are amplified to a level equivalent to that of the sound pressure Pgen by the amplifier 18, and the amplified notification sound signals are emitted from the speaker 19 as a notification sound. Then, the DSP 13 returns to Step SA2 and, if the vehicle is moving, repeats the operations at Step SA2 to SA6 to generate and emit a notification sound whose sound frequency band and sound pressure change based on the octave analysis results for the picked up ambient noises.

(2) Operations in Input Waveform Analysis Processing

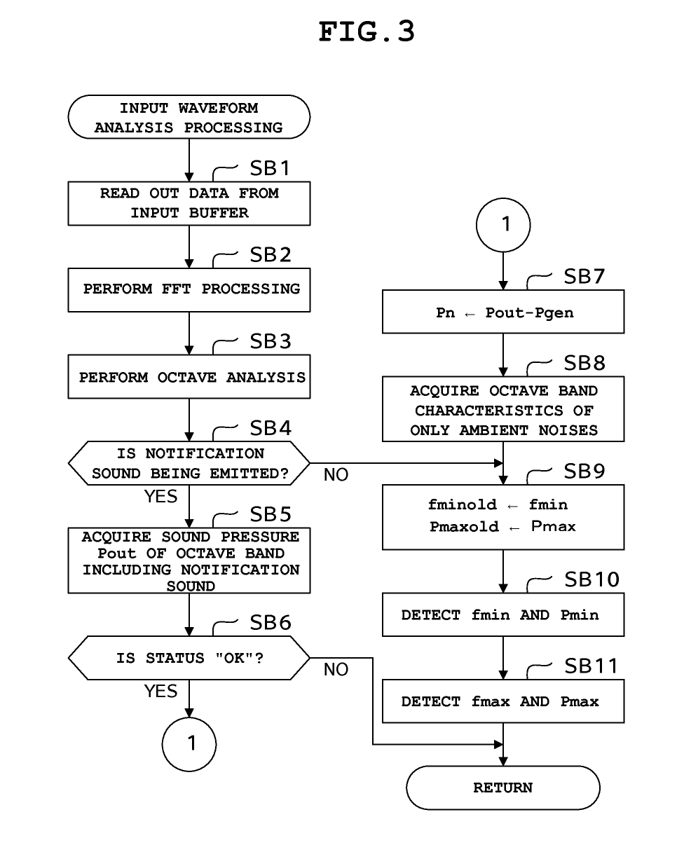

Next, operations in the input waveform analysis processing will be described with reference to FIG. 3. When the input waveform analysis processing is performed via Step SA4 of the above-described main routine (see FIG. 2), the DSP 13 proceeds to Step SB1 shown in FIG. 3, and sequentially reads out the ambient noise data amounting to a predetermined amount of time (amounting to a predetermined number of samples) which have been loaded into the input buffer area of the RAM 16. Then, at subsequent Step SB2, the DSP 13 performs FFT processing on the series of read out ambient noise data, and performs a known frequency analysis.

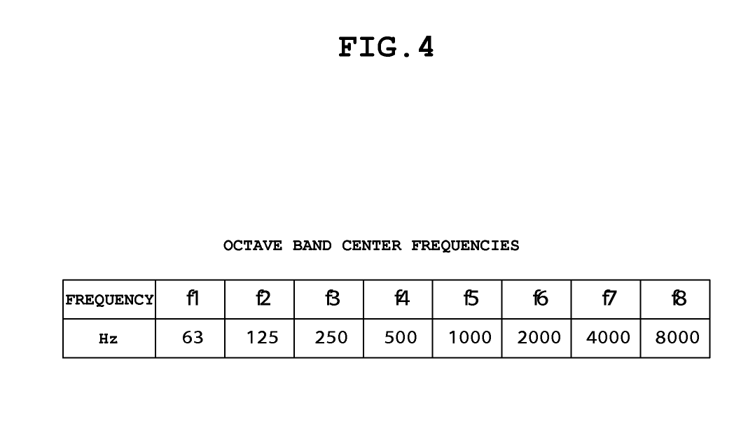

Next, at Step SB3, the DSP 13 performs octave analysis on frequency analysis results (amplitude spectrum of each frequency component) acquired at Step SB2. That is, the DSP 13 detects the sound pressures (octave band levels) P1 to P8 of the octave bands (bandwidth of a single octave from f/√2 to f·√2) that have the frequencies f1 to f8 shown in FIG. 4 as center frequencies. Then, the DSP 13 proceeds to Step SB4 and judges whether or not a notification sound is being outputted and emitted from the speaker 19. When a notification sound is not being outputted and emitted, the judgment result is “NO”, and therefore the DSP 13 proceeds to Step SB9 described hereafter.

Conversely, when a notification sound is being outputted and emitted, the judgment result at Step SB4 is “YES”, and therefore the DSP 13 proceeds to Step SB5. At Step SB5, the DSP 13 acquires the sound pressure Pout of an octave band including the notification sound from among the sound pressures P1 to P8 of the octave bands having the center frequencies f1 to f8 acquired by the octave analysis of ambient noises including the notification sound.

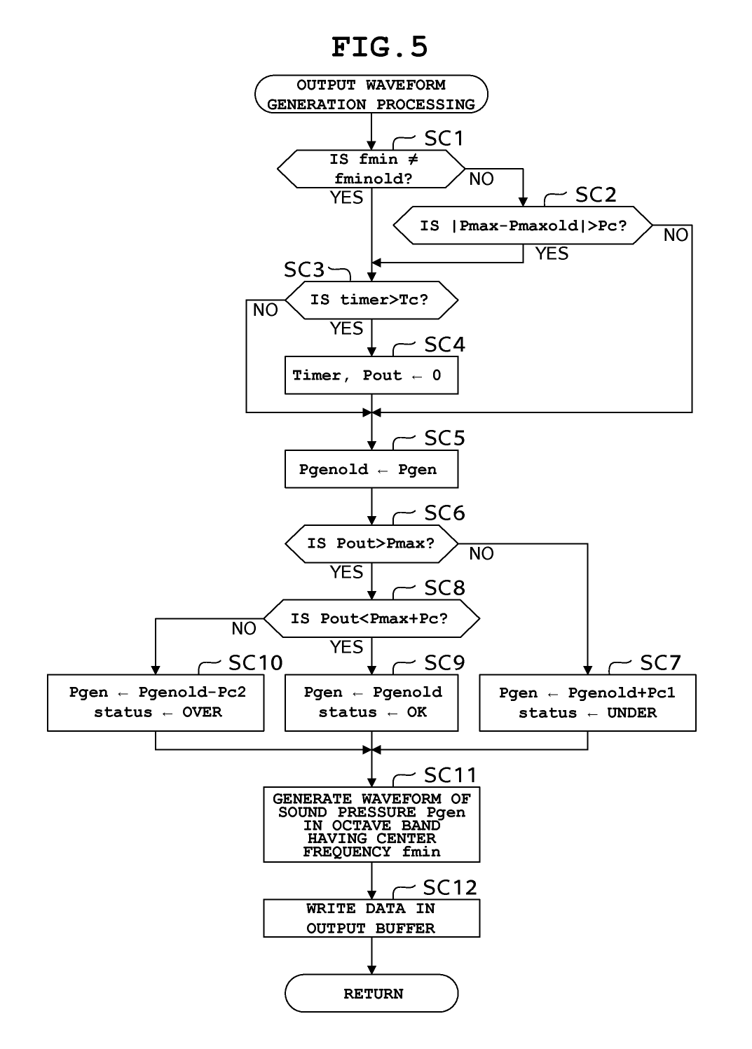

Although it is mentioned in an explanation of the operations in the output waveform generation processing (see FIG. 5) described hereafter, the octave band including the notification sound is an octave band of the ambient noises which has the lowest sound pressure. The center frequency of this octave band is referred to as fn. The center frequency fn indicates that it corresponds to one of the center frequencies f1 to f8 of the octave bands used in the octave analysis.

Next, at Step SB6, the DSP 13 judges whether or not the status flag “status” determined in the output waveform generation processing (see FIG. 5) described hereafter is “OK”. The status flag “status” is to indicate the status of a notification sound emitted based on an output waveform (notification sound data). When the status flag “status” is “OK”, the sound pressure Pout is within an appropriate range. When the status flag “status” is “UNDER”, the sound pressure Pout is lower than the appropriate range. When the status flag “status” is “OVER”, the sound pressure Pout is higher than the appropriate range.

When the status flag “status” is “UNDER” or “OVER”, or in other words, when it is in a state other than “OK”, the judgment result at Step SB6 is “NO”, and therefore the DSP 13 ends the input waveform analysis processing. When the sound pressure Pout is within the appropriate range and the status flag “status” is “OK”, the judgment result at Step SB6 is “YES”, and therefore the DSP 13 proceeds to Step SB7. At Step SB7, the DSP 13 subtracts the notification sound pressure Pgen generated by the output waveform generation processing (described hereafter) from the sound pressure Pout of the octave band (center frequency fn) including the notification sound acquired at Step SB5, and calculates the sound pressure Pn.

That is, it is not possible to measure the sound pressure of only the ambient noises in the octave band (center frequency fn) including the notification sound among the sound pressures P1 to P8 of the octave bands having the center frequencies f1 to f8 acquired by the octave analysis of the ambient noises including the notification sound. Therefore, at Step SB7, the DSP 13 subtracts the notification sound pressure Pgen which is actually being emitted, from the sound pressure Pout of the octave band (center frequency fn) including the notification sound, and thereby corrects the sound pressure of the octave band having the center frequency fn to the sound pressure Pn of only the ambient noises.

At subsequent Step SB8, the DSP 13 changes, among the sound pressures P1 to P8 of the octave bands having the center frequencies f1 to f8 that have been acquired by the octave analysis of the ambient noises including the notification sound, the sound pressure of the octave band having the center frequency fn corrected at Step SB7 to the sound pressure Pn of only the ambient noises, and thereby acquires the octave characteristics (the sound pressures P1 to P8 of the octave bands having the center frequencies f1 to f8) of only the ambient noises. The DSP 13 then proceeds to Step SB9 and saves the previously detected fmin value in a register fminold, and the previously detected Pmax value in a register Pmaxold, in order to detect new fmin and Pmax at Step SB10 to Step SB11 described hereafter.

Next, at Step SB10, the DSP 13 detects the center frequency fmin and the sound pressure Pmin of the octave band of the ambient noises which has the lowest sound pressure, from the octave band characteristics (the sound pressures P1 to P8 of the octave bands having the center frequencies f1 to f8) of only the ambient noises acquired at Step SB8. At subsequent Step SB11, the DSP 13 detects the center frequency fmax and the sound pressure Pmax of the octave band of the ambient noises which has the highest sound pressure, and ends the input waveform analysis processing.

As described above, in the input waveform analysis processing, the DSP 13 sequentially reads out ambient noise data amounting to a predetermined amount of time (amounting to a predetermined number of samples) which have been loaded into the input buffer area of the RAM 16, performs FFT (fast Fourier transform) processing on the ambient noise data, and performs frequency analysis. Subsequently, on frequency analysis results (amplitude spectrum for each frequency component) acquired thereby, the DSP 13 performs octave analysis for detecting the sound pressures (octave band levels) of respective octave bands having the center frequencies f1 to f8. If a notification sound is being outputted and emitted from the speaker 19, the DSP 13 acquires the sound pressure Pout of an octave band including the notification sound from among the sound pressures P1 to P8 of octave bands having the center frequencies f1 to f8 acquired by the octave analysis of ambient noises including the notification sound.

Then, if the sound pressure Pout is within an appropriate range (when the status flag “status” is “OK”), the DSP 13 subtracts the sound pressure Pgen of the notification sound which is actually being emitted, from the sound pressure Pout of the octave band including the notification sound. Subsequently, the DSP 13 corrects the sound pressure of an octave band having the center frequency Fn to the sound pressure Pn of only the ambient noises, and thereby acquires the octave band characteristics (the sound pressures P1 to P8 of octave bands having the center frequencies f1 to f8) of only the ambient noises. Then, the DSP 13 detects the center frequency fmin and the sound pressure Pmin of an octave band of the ambient noises which has the lowest sound pressure, and the center frequency fmax and the sound pressure Pmax of an octave band of the ambient noises which has the highest sound pressure, from the acquired octave characteristics (the sound pressures P1 to P8 of the octave bands having the center frequencies f1 to f8) of only the ambient noises.

(3) Operations in Output Waveform Generation Processing

Next, the operations in the output waveform generation processing will be described with reference to FIG. 5. When the output waveform generation processing is performed via Step SA5 of the above-described main routine (see FIG. 2), the DSP 13 proceeds to Step SC1 shown in FIG. 5. At Step SC1, the DSP 13 judges whether or not the center frequency fmin currently detected by the above-described input wavelength analysis processing is different from the preceding detected center frequency fmin stored in the register fminold. That is, the DSP 13 judges whether or not the center frequency fmin of the octave band of the ambient noises which has the lowest sound pressure has changed from the preceding center frequency fmin. When judged that the center frequency fmin has not changed from the previous center frequency fmin, the DSP 13 proceeds to Step SC2 since the judgment result at Step SC1 is “NO”. Conversely, when judged that the center frequency fmin has changed from the previous center frequency fmin, the DSP 13 proceeds to Step SC3 since the judgment result at Step SC1 is “YES”.

At Step SC2, the DSP 13 judges whether or not the differential absolute value (amount of change) of the sound pressure Pmax currently detected by the above-described input waveform analysis processing and the preceding detected sound pressure Pmax stored in the register Pmaxold is greater than an allowable value Pc. That is, the DSP 13 judges whether or not the amount of change in the sound pressure Pmax of the octave band (center frequency fmax) of the ambient noises which has the highest sound pressure from the preceding sound pressure Pmax exceeds the allowable value Pc. When judged that the amount of change in the sound pressure Pmax from the preceding sound pressure Pmax does not exceed the allowable value Pc, the DSP 13 proceeds to Step SC5 since the judgment result at Step SC2 is “NO”.

Conversely, when judged that the amount of change in the sound pressure Pmax from the preceding sound pressure Pmax exceeds the allowable value Pc, the DSP 13 proceeds to Step SC3 since the judgment result at Step SC2 is “YES”. At Step SC3, the DSP 13 judges whether or not the value of a timer inside the DSP 13 which measures time elapsed from the start of the generation of output waveform (notification sound data) has exceeded a generated waveform change minimum time Tc. When judged that the value of the timer has not exceeded the generated waveform change minimum time Tc, the DSP 13 proceeds to Step SC5 since the judgment result is “NO”.

Conversely, when judged that the value of the timer has exceeded the generated waveform change minimum time Tc, the DSP 13 proceeds to Step SC4 since the judgment result at Step SC3 is “YES”. At Step SC4, the DSP 13 resets the timer and the sound pressure Pout to zero. Note that the sound pressure Pout, which has been acquired by the above-described input waveform analysis processing (see FIG. 3), indicates the sound pressure of the octave band including the notification sound.

At Step SC1 to SC3, in a case where the center frequency fmin of the octave band of the ambient noises which has the lowest sound pressure has changed from the preceding center frequency fmin, and the value of the timer has exceeded the generated waveform change minimum time Tc, or in a case where the center frequency fmin of the octave band of the ambient noises which has the lowest sound pressure has not changed from the preceding center frequency fmin but the amount of change in the sound pressure Pmax of the octave band (center frequency fmax) of the ambient noises which has the highest sound pressure from the preceding sound pressure Pmax has exceeded the allowable value Pc and the value of the timer has exceeded the generated waveform change minimum time Tc, the DSP 13 proceeds to Step SC4, as described above. Then, after setting the sound pressure Pout to “0” at Step SC4, the DSP 13 performs the operations of Step SC5 and subsequent steps. That is, the DSP 13 starts generating a new output waveform after once setting the sound pressure of the output waveform (notification sound data) to zero.

On the other hand, in a case where the center frequency fmin of the octave band of the ambient noises which has the lowest sound pressure has changed from the preceding center frequency fmin but the value of the timer has not exceeded the generated waveform change minimum time Tc, or in a case where the center frequency fmin of the octave band of the ambient noises which has the lowest sound pressure has not changed from the preceding center frequency fmin and the amount of change in the sound pressure Pmax of the octave band (center frequency fmax) of the ambient noises which has the highest sound pressure from the preceding sound pressure Pmax has not exceeded the allowable value Pc, the DSP 13 proceeds to Step SC5 and saves the sound pressure Pgen of the current output waveform (notification sound data) in the register Pgenold as the preceding value. That is, the preceding generated output waveform is again generated as the current output waveform.

Next, at Step SC6, the DSP 13 judges whether or not the sound pressure Pout of the octave band including the notification sound is higher than the sound pressure Pmax of the octave band (center frequency fmax) of the ambient noises which has the highest sound pressure. When the sound pressure Pout is lower than the sound pressure Pmax, the judgment result is “NO”, and therefore the DSP 13 proceeds to Step SC7. At Step SC7, the DSP 13 adds a constant Pc1 to the preceding sound pressure Pgen stored in the register Pgenold and updates the sound pressure Pgen of the current output waveform (notification sound data). In addition, the DSP 13 sets the status flag “status” to “UNDER” to indicate a state of Pout<Pmax, and proceeds to Step SC11 described hereafter.

Conversely, when the sound pressure Pout is higher than the sound pressure Pmax, the judgment result at Step SC6 is “YES”, and therefore the DSP 13 proceeds to Step SC8. At Step SC8, the DSP 13 judges whether or not the sound pressure Pout is lower than a value (Pmax+Pc) acquired by adding the increment value Pc to the sound pressure Pmax. When the sound pressure Pout is within an appropriate range (Pmax<Pout<Pmax+Pc) that is higher than the sound pressure Pmax and lower than the value acquired by adding the constant Pc to the sound pressure Pmax, the judgment result is “YES”, and therefore the DSP 13 proceeds to Step SC9. At Step SC9, the DSP 13 directly updates the preceding sound pressure Pgen stored in the register Pgenold with the sound pressure Pgen of the current output waveform. In addition, the DSP 13 sets the status flag “status” to “OK” to indicate a state in which the sound pressure Pout is within the appropriate range, and then proceeds to Step SC11 described hereafter.

Conversely, when the sound pressure Pout is higher than the value (Pmax+Pc) acquired by adding the constant Pc to the sound pressure Pmax, the judgment result at Step SC8 is “NO”, and therefore the DSP 13 proceeds to Step SC10. At Step SC10, the DSP 13 updates the sound pressure Pgen of the current output waveform (notification sound data) to a value (Pgenold-Pc2) acquired by subtracting a constant Pc2 from the preceding sound pressure Pgen stored in the register Pgenold. In addition, the DSP 13 sets the status flag “status” to “OVER” to indicate a state of Pout>Pmax+Pc, and proceeds to Step SC11 described hereafter. Note that the relationship among the constants Pc, Pc1, and Pc2 is Pc>Pc1>Pc2.

When the sound pressure Pgen is controlled as described to be almost equal to the sound pressure Pmax of the octave band (center frequency fmax) of the ambient noises which has the highest sound pressure, the DSP 13 proceeds to Step SC11 and generates output waveform (notification sound data) of the sound pressure Pgen in the octave band (center frequency fmin) of the ambient noises which has the lowest sound pressure. Then, at Step SC12, the DSP 13 stores the generated output waveform (notification sound data) in the output buffer area of the RAM 16, and ends the output waveform generation processing. Note that this output waveform (notification sound data) is generated by, for example, white noise (or pink noise) being generated and band-pass filtering of a frequency band corresponding to the octave band having the center frequency fmin being performed on the white noise.

As described above, in the output waveform generation processing, the output waveform (notification sound data), of which the sound pressure Pgen has been controlled in a follow-up manner such that the sound pressure Pout of the octave band including the notification sound comes within an appropriate range (Pmax<Pout<Pmax+Pc) where the sound pressure Pout becomes almost equal to the sound pressure Pmax of the octave band (center frequency fmax) of the ambient noises which has the highest sound pressure, is generated in the octave band (center frequency fmin) of the ambient noises which has the lowest sound pressure, based on the octave analysis results of the ambient noises acquired by the above-described input waveform analysis processing.

According to the present embodiment, when a vehicle is detected to be moving based on vehicle speed pulse signals supplied by the vehicle, ambient noises picked up by the microphone 10 are sampled and loaded into the input buffer area of the RAM 16 as ambient noise data. Then, frequency analysis is performed on the ambient noise data by FFT processing, and octave analysis is performed on the frequency analysis results, whereby the sound pressures (octave band levels) of respective octave bands having the center frequencies f1 to f8 are detected.

When ambient noises are picked up while a notification sound is being outputted and emitted from the speaker 19, and the sound pressure Pout of an octave band including the notification sound is within an appropriate range (status flag “status” is OK) among the sound pressures P1 to P8 of octave bands having the center frequencies f1 to f8 acquired by the octave analysis of the ambient noises including the notification sound, the sound pressure Pgen of the notification sound that is actually being emitted is subtracted from the sound pressure Pout of the octave band including the notification sound, and the sound pressure of an octave band having the center frequency fn is corrected to the sound pressure Pn of only the ambient noises, whereby the octave band characteristics (sound pressures P1 to P8 of octave bands having the center frequencies f1 to f8) of only the ambient noises are acquired. Subsequently, the center frequency fmin and the sound pressure Pmin of an octave band of the ambient noises which has the lowest sound pressure, and the center frequency fmax and the sound pressure Pmax of an octave band of the ambient noises which has the highest sound pressure are detected from the acquired octave characteristics (sound pressures P1 to P8 of the octave bands having the center frequencies f1 to f8) of only the ambient noises.

Then, in the octave band (center frequency fmin) of the ambient noises which has the lowest sound pressure, output waveform (notification sound data) is generated whose sound pressure Pgen has been controlled in a follow-up manner such that the sound pressure Pout of the octave band including the notification sound comes within an appropriate range (Pmax<Pout<Pmax+Pc) where the sound pressure Pout becomes almost equal to the sound pressure Pmax of the octave band (center frequency fmax) of the ambient noises which has the highest sound pressure. Therefore, a notification sound can be generated that is not lost among ambient noise even in noisy locations and does not unnecessarily cause a noise disturbance in quiet locations.

Note that, although the above-described embodiment has a configuration in which whether or not a vehicle is moving is judged based on vehicle speed pulse signals and a notification sound is generated when the vehicle is detected to be moving, the present invention is not limited thereto, and a configuration may be adopted in which a notification sound is generated only between when a vehicle starts moving until reaching a predetermined speed. This is because road noise generated between the tires and a road surface increases when a vehicle moves at a predetermined speed or higher, and the notification sound becomes unnecessary as a result.

In addition, although a notification sound is generated based on white noise (or pink noise) in the present embodiment, the present invention is not limited thereto, and a configuration may be adopted in which a sound that is easily recognized by pedestrians, such as a sound from an instrument, chimes or human voice filtered to accord with a frequency band where ambient noise is smallest may be used as a notification sound.

While the present invention has been described with reference to the preferred embodiments, it is intended that the invention be not limited by any of the details of the description therein but includes all the embodiments which fall within the scope of the appended claims.

What is claimed is:

1. A sound producing device for a vehicle comprising:
an analyzing section which picks up noises around the vehicle and analyzes frequency characteristics of the picked up noises;
an acquiring section which acquires frequency characteristics of ambient noises from the noises around the vehicle which have been analyzed by the analyzing section;
a detecting section which detects (a) a sound pressure of a frequency having a lowest sound pressure and (b) a sound pressure of a frequency having a highest sound pressure from the frequency characteristics of the ambient noises acquired by the acquiring section; and
a sound producing section which produces a notification sound at the frequency of the ambient noises having the lowest sound pressure which has been detected by the detecting section, and at a sound pressure corresponding to the highest sound pressure of the ambient noises detected by the detecting section.

2. The sound producing device for a vehicle according to claim 1, wherein the acquiring section acquires frequency characteristics of ambient noises by canceling components of a notification sound from the frequency characteristics of the noises around the vehicle which have been analyzed by the analyzing section.

3. The sound producing device for a vehicle according to claim 1, wherein the analyzing section includes a sensing section which senses whether the vehicle is moving, and picks up noises around the vehicle including the notification sound, when the sensing section senses that the vehicle is moving.

4. The sound producing device for a vehicle according to claim 1, wherein the acquiring section acquires frequency characteristics of the ambient noises by subtracting an emitted sound pressure of the notification sound from a sound pressure of a frequency band including the notification sound, among sound pressures of frequency bands of the noises around the vehicle which have been analyzed by the analyzing section.

5. A non-transitory computer-readable storage medium having stored thereon a program that is executable by a computer used in a sound producing device for a vehicle, the program being executable by the computer to perform functions comprising:
analysis processing for picking up noises around the vehicle and analyzing frequency characteristics of the picked up noises;
acquisition processing for acquiring frequency characteristics of ambient noises from the noises around the vehicle which have been analyzed by the analysis processing;
detection processing for detecting (a) a sound pressure of a frequency having a lowest sound pressure and (b) a sound pressure of a frequency having a highest sound pressure from the frequency characteristics of the ambient noises acquired by the acquiring section; and
sound production processing for produces a notification sound at the frequency of the ambient noises having the lowest sound pressure which has been detected by the detection processing, and at a sound pressure corresponding to the highest sound pressure of the ambient noises detected by the detection processing.

6. The non-transitory computer-readable storage medium having stored thereon a program that is executable by a computer used in a sound producing device for a vehicle according to claim 5, wherein the program being executable by the computer to perform further functions wherein:
the acquisition processing acquires frequency characteristics of ambient noises by canceling components of a notification sound from the frequency characteristics of the noises around the vehicle which have been analyzed by the analysis processing.

7. The non-transitory computer-readable storage medium having stored thereon a program that is executable by a computer used in a sound producing device for a vehicle according to claim 5, wherein the program being executable by the computer to perform further functions wherein:
the analysis processing includes sensor processing for sensing whether the vehicle is moving, and picking up noises around the vehicle including the notification sound, when the sensor processing senses that the vehicle is moving.

8. The non-transitory computer-readable storage medium having stored thereon a program that is executable by a computer used in a sound producing device for a vehicle according to claim 5, wherein the program being executable by the computer to perform further functions wherein:
the acquisition processing acquires frequency characteristics of the ambient noises by subtracting an emitted sound pressure of the notification sound from a sound pressure of a frequency band including the notification sound, among sound pressures of frequency bands of the noises around the vehicle which have been analyzed by the analysis processing.

9. An information processing method used for a sound producing device for a vehicle, comprising:
an analyzing step of picking up noises around the vehicle and analyzing frequency characteristics of the picked up noises;
an acquiring step of acquiring frequency characteristics of ambient noises from the noises around the vehicle which have been analyzed in the analyzing step;
a detecting step of detecting (a) a sound pressure of a frequency having a lowest sound pressure and (b) a sound pressure of a frequency having a highest sound pressure from the frequency characteristics of the ambient noises acquired in the acquiring step; and
a sound production step of producing a notification sound at the frequency of the ambient noises having the lowest sound pressure which has been detected in the detecting step, and at a sound pressure corresponding to the highest sound pressure of the ambient noises detected in the detecting step.

10. The information processing method used for a sound producing device for a vehicle according to claim 9, wherein the acquisition step acquires frequency characteristics of ambient noises by canceling components of a notification sound from the frequency characteristics of the noises around the vehicle which have been analyzed in the analyzing step.

11. The information processing method used for a sound producing device for a vehicle according to claim 9, wherein the analyzing step includes a sensor step of sensing whether the vehicle is moving, and picks up noises around the vehicle including the notification sound, when the sensor step senses that the vehicle is moving.

12. The information processing method used for a sound producing device for a vehicle according to claim 9, wherein the acquiring step acquires frequency characteristics of the ambient noises by subtracting an emitted sound pressure of the notification sound from a sound pressure of a frequency band including the notification sound, among sound pressures of frequency bands of the noises around the vehicle which have been analyzed by the analyzing step.
